(19) United States
(12) Patent Application Publication
(10) Pub. No.: US 2026/0259889 A1
(43) Pub. Date: Sep. 3, 2026

(54) DATE CLASSIFIER MACHINE LEARNING MODEL

(71) Applicant: Microsoft Technology Licensing, LLC, Redmond, WA (US)

(72) Inventors: Justin James WAGLE, Pacifica, CA (US); Sunando SENGUPTA, Reading (GB); Rajath Kumar RAVI, Reading (GB)

(73) Assignee: Microsoft Technology Licensing, LLC, Redmond, WA (US)

(21) Appl. No.: 19/067,688

(22) Filed: Feb. 28, 2025

(51) Int. Cl. G06F 16/2458; G06N 3/0499

(52) U.S. Cl. CPC G06F 16/2477; G06N 3/0499

(57) ABSTRACT

A computing system including one or more processing devices configured to receive an input query. At a query parsing machine learning (ML) model, the one or more processing devices extract a temporal substring from the input query. At a sentence embedding ML model, the one or more processing devices compute a sentence embedding of the temporal substring. At a date classifier ML model, the one or more processing devices compute a date embedding based at least in part on the sentence embedding and perform classification on the date embedding to identify an output date including a day, a month, and a year indicated by the temporal substring. The one or more processing devices output the output date to an additional computing process.

### BACKGROUND

A wide variety of computing tasks rely on temporal data. For example, a user may enter a search query including a time and/or date range to instruct a computing system to search for a file or a network location associated with a specific time. As another example, a user may instruct a computing system to create a calendar event or set a reminder for a specific time.

As machine-learning-based assistant systems advance, those systems are increasingly used for tasks such as event scheduling and historical data retrieval that rely on temporal data. Machine-learning-based assistant systems allow these tasks to be performed using semantic inputs in which users specify control instructions for a machine-learning-based assistant in natural-language form. The assistant system then performs natural language processing on the semantic input to compute an output based at least in part on the semantic content expressed in the input. For example, the semantic input may guide the machine-learning-based assistant system to perform a user-specified action at a separate application program, such as performing a search for a file semantically described in the user input.

### SUMMARY

According to one aspect of the present disclosure, a computing system is provided, including one or more processing devices configured to receive an input query. At a query parsing machine learning (ML) model, the one or more processing devices are further configured to extract a temporal substring from the input query. At a sentence embedding ML model, the one or more processing devices are further configured to compute a sentence embedding of the temporal substring. At a date classifier ML model, the one or more processing devices are further configured to compute a date embedding based at least in part on the sentence embedding. At the date classifier ML model, the one or more processing devices are further configured to perform classification on the date embedding to identify an output date including a day, a month, and a year indicated by the temporal substring. The one or more processing devices are further configured to output the output date to an additional computing process.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows a computing system at which one or more processing devices are configured to receive and process an input query to compute an output date, according to one example embodiment.

FIG. 2 schematically shows the computing system when a temporal substring of the input query is a natural-language descriptor of the output date, according to the example of FIG. 1.

FIG. 3 schematically shows the computing system in an example in which the one or more processing devices are further configured to receive user-specific calendar data, according to the example of FIG. 1.

FIG. 4A schematically shows the computing system when the one or more processing devices are configured to compute a training dataset of a date classifier ML model, according to the example of FIG. 1.

FIG. 4B schematically shows the computing system when the one or more processing devices are configured to process the training dataset to train the date classifier ML model, according to the example of FIG. 4A.

FIG. 5A shows a flowchart of a method for use with a computing system to perform semantic date classification on text input, according to the example of FIG. 1.

FIGS. 5B-5E show additional steps of the method of FIG. 5A that may be performed in some examples.

FIG. 6 schematically shows an example computing environment in which the computing system of FIG. 1 may be instantiated.

### DETAILED DESCRIPTION

As discussed above, temporal criteria frequently occur in user queries to machine-learning-based assistant systems across a variety of different specified tasks. Due to the high variability among natural-language statements that refer to times and dates, these temporal criteria can be specified in many different ways in semantic inputs. Some example semantic queries that include temporal information are provided as follows:

“Set a reminder for 6:30 p. m. on Jan. 23, 2025.”

“Who attended the meeting I had on the day before Halloween in 2023?”

“Create a one-hour-long calendar event at noon next Moday.”

“Restore this file to the backup saved two days ago.”

“Move all emails I received last month to the ‘Old’ folder.”

“Show me the photos I took on June 5th.”

“Remind me to call my father on his birthday.”

As shown in the above examples, natural-language indicators of dates and times can have a variety of formats. For example, “the day before Halloween in 2023” in the second example could also have been written as “10/30/2023,” “30/10/2023,” “10/30/23,” “30/10/23,” “Oct. 30, 2023,” or “Oct. 30, 2023.” In addition, rather than specifying an absolute date and/or time that is independent of the current date and/or time, some natural-language indicators of temporal criteria are expressed in relative terms, such as “two days ago.” Temporal queries may also omit information, such as the year in the example “Show me the photos I took on June 5th,” or may include typographical errors, such as in the example “noon next Monday.” A temporal query may also specify a range of dates and/or times, as in the example “last month.” Additionally or alternatively, a temporal query may refer to a user-specific date and/or time that is defined with reference to a user's calendar data, as in the example “Remind me to call my father on his birthday.” In addition to those listed above, other forms of variability may also occur in semantically defined temporal queries.

When user inputs have a consistent format, rule-based or heuristic based approaches such as regular expression matching may be used to consistently extract time and date information from those inputs. However, since dates and times may be expressed in natural-language queries in a variety of different ways, it is difficult to construct a set of rules or heuristics that consistently achieve accurate date and/or time classification of natural language inputs.

Instead of discrete rules or heuristics, machine-learning-based approaches have instead been used to extract temporal information from semantic queries. For example, information may be extracted from a semantic query by computing a text embedding of the input query at a text embedding machine learning (ML) model such as BERT or GPT. The text embedding may then be matched to a region of an embedding space in which the text embedding is located. Accordingly, the semantic contents of the input query may be extracted.

Existing text-embedding-based approaches often have low performance when used to extract temporal information from natural-language queries. Embedding space regions that encode temporal data only make up small portions of the embedding spaces of pretrained text embedding models such as BERT or GPT, since these embedding models are trained on text data that varies widely in source and subject matter. Thus, dates and/or times that are similar to each other may be difficult to distinguish within the output of the embedding model, thereby leading to inaccurate classification.

In order to address the above shortcomings of previous temporal data identification techniques, a processing pipeline that further includes a date classifier ML model has been developed. The processing pipeline includes a query parsing ML model that identifies a temporal substring of a user input, as well as a sentence embedding ML model that computes a sentence embedding of the temporal substring. The date classifier ML model is trained to classify different locations within the embedding space of the sentence embedding ML model to obtain corresponding dates within a date range. Using the date classifier ML model, the processing pipeline achieves higher date classification accuracy when making use of the natural language processing capabilities of the sentence embedding ML model to extract semantic information from the user input. The approaches discussed below therefore achieve both high accuracy and natural-language processing flexibility.

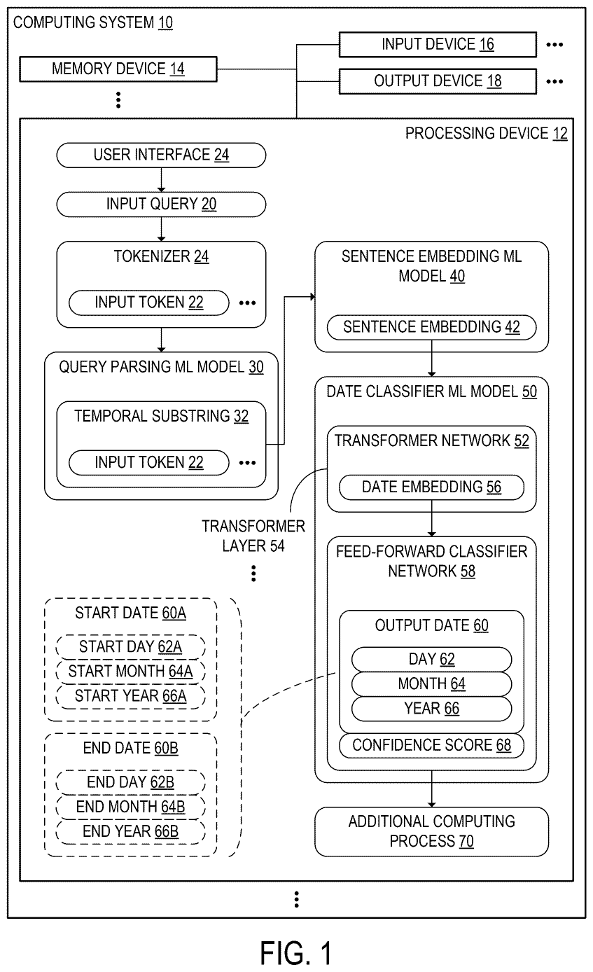

FIG. 1 schematically shows a computing system 10 at which one or more processing devices 12 are configured to receive and process an input query 20 to compute an output date 60. The computing system 10 includes one or more processing devices 12 and one or more memory devices 14. The one or more processing devices 12 may, for example, include one or more central processing units (CPUs), graphics processing units (GPUs), neural processing units (NPUs), and/or other types of hardware accelerators. The one or more memory devices 14 may, for example, include one or more volatile memory devices and one or more non-volatile storage devices.

In some examples, the one or more processing devices 12 and the one or more memory devices 14 may be distributed among a plurality of different physical computing devices. For example, the physical computing devices included in the computing system 10 may have a server-client configuration. In other examples, the computing system 10 may be implemented at a single physical computing device. For example, the computing system 10 may be configured to process the input query 20 entirely at one or more onboard processing devices in examples in which the output date 60 is computed from confidential user data.

The computing system 10 is shown at inferencing time in the example of FIG. 1. In this example, the one or more processing devices 12 are configured to receive the input query 20 via a user interface 24. The user interface utilizes one or more input devices 16 and one or more output devices 18 included in the computing system 10 to enable user interaction with the computing system 10 and to present outputs of computing processes to the user. For example, the user interface 24 may be a graphical user interface (GUI) or an audio interface.

Subsequently to receiving the input query 20, the one or more processing devices 12 are further configured to process the input query 20 at a tokenizer 24 to convert the input query 20 into a sequence of input tokens 22. Thus, the one or more processing devices 12 are configured to convert a text input into an input format of a query parsing ML model 30.

At the query parsing ML model 30, the one or more processing devices 12 are further configured to process the sequence of input tokens 22 to extract a temporal substring 32 from the input query 20. The temporal substring 32 is a subset of the plurality of input tokens 22 received the tokenizer 24 that are determined to have time-related semantic content. For example, in the input query “Restore this file to the backup saved two days ago,” the query parsing ML model 30 may select the input tokens 22 included in the substring “two days ago” as the temporal substring 32. In some examples, two or more substrings of the input query 20 may be identified as temporal substrings 32.

The one or more processing devices 12 are further configured to process the temporal substring 32 at a sentence embedding ML model 40. At the sentence embedding ML model 40, the one or more processing devices 12 are configured to compute a sentence embedding 42 of the temporal substring 32. The temporal substring 32 is accordingly mapped into an embedding vector space of the sentence embedding ML model 40.

The one or more processing devices 12 are further configured to process the sentence embedding 42 at a date classifier ML model 50. At the date classifier ML model 50, the one or more processing devices 12 are configured to compute a date embedding 56 based at least in part on the sentence embedding 42. The one or more processing devices 12 are further configured to perform classification on the date embedding 56 to identify an output date 60. Thus, the one or more processing devices 12 are configured to extract a date semantically indicated by the temporal substring 32.

The output date 60 includes a day 62, a month 64, and a year 66. The one or more processing devices 12 may be further configured to compute a confidence score 68 associated with its identification of the output date 60. In some examples, the one or more processing devices 12 are configured to compute a start date 60A and an end date 60B at the date classifier ML model 50 by performing classification on the date embedding 56. In such examples, the start date 60A includes a start day 62A, a start month 64A, and a start year 66A, and the end date 60B includes an end day 62B, an end month 64B, and an end year 66B. The start date 60A and the end date 60B may be equal in examples in which the temporal substring 32 indicates a single date rather than a range of multiple dates. In examples in which a start date 60A and an end date 60B are computed at the date classifier ML model 50, the confidence score 68 may indicate a confidence that the date indicated by the temporal substring 32 is within the date range specified by the start date 60A and the end date 60B.

The one or more processing devices 12 are further configured to output the output date 60 to an additional computing process 70. In some examples, the output date 60 is output in a JSON format. An example output of the date classifier ML model 50 is shown below:

```
{
  “temporal_input_query”: “1st of july in 2024”,
  “start_date”: “2024-07-01”,
  “end_date”: “2024-07-01”,
  “confidence”: 0.9865
}
```

In the example of FIG. 1, the architecture of the date classifier ML model 50 includes a transformer network 52 and a feed-forward classifier network 58. The transformer network 52 includes a plurality of transformer layers 54 and is configured to compute the date embedding 56 based at least in part on the sentence embedding 42. Accordingly, the transformer network 52 may upscale an embedding space region of the sentence embedding ML model 40 that encodes date-related semantic information. The feed-forward classifier network 58 is configured to perform classification on the date embedding 56 to compute the output date 60. By computing the date embedding 56 from the sentence embedding 42, the transformer network 52 converts the sentence embedding 42 into a form that the feed-forward classifier network 58 can classify more accurately.

Although, in the example of FIG. 1, days are the smallest level of granularity predicted at the date classifier ML model 50, the date classifier ML model 50 may be configured to predict shorter time intervals (e.g., specific hours within a day) in other examples. Additionally or alternatively, a regression model may be used in place of the date classifier ML model 50. In such examples, the regression model may be configured to compute a continuous-valued time estimate based at least in part on the sentence embedding 42.

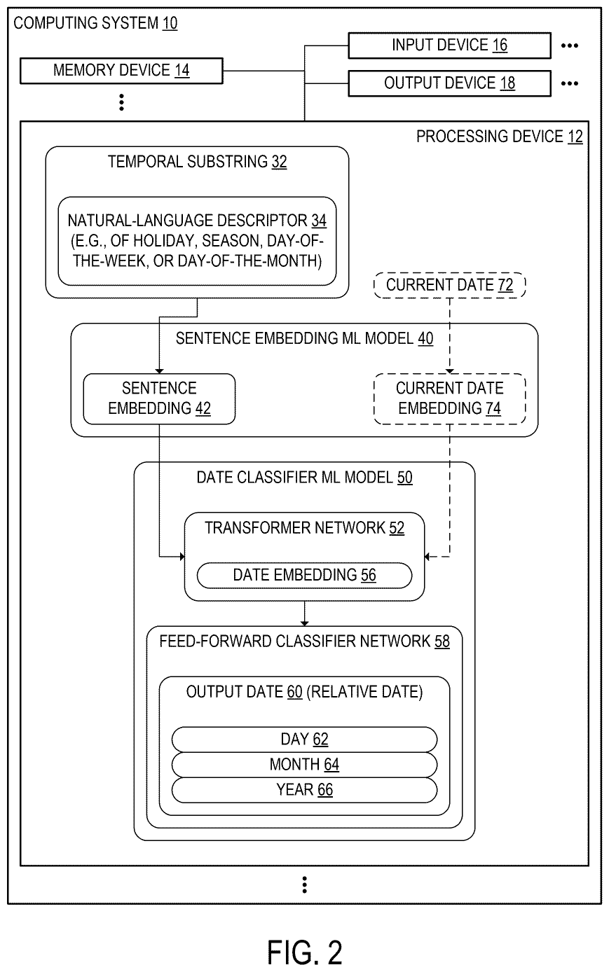

FIG. 2 schematically shows the computing system 10 when the temporal substring is a natural-language descriptor 34 of the output date 60. For example, the temporal substring 32 may include a natural-language indication of a holiday, a season, a day-of-the-week, or a day-of-the-month. Examples of these types of temporal substrings are “Christmas,” “last spring,” “next Saturday,” and “the first day of each month.” Using the query parsing ML model 30, the sentence embedding ML model 40, and the date classifier ML model 50 as discussed above, the one or more processing devices 12 may extract the output date 60 from such a natural language descriptor 34 even when the natural language descriptor 34 does not explicitly specify the output date 60. In contrast, existing heuristic-based date extraction techniques are typically unable to process such natural-language descriptors 34.

In some examples, as shown in FIG. 2, the one or more processing devices 12 are further configured to receive a current date 72 as input. The current date 72 is the date on which the one or more processing devices 12 process the input query 20. At the sentence embedding ML model 40, the one or more processing devices 12 may be further configured to compute a current date embedding 74 based at least in part on the current date 72. At the date classifier ML model 50, the one or more processing devices 12 are further configured to compute the output date 60 as a relative date based at least in part on the current date embedding 74.

In one example of relative date identification, the one or more processing devices 12 are configured to receive a current date “2024-01-24” and a temporal substring “the day after tomorrow.” This temporal substring 32 is expressed with reference to the current date 72. By converting the temporal substring 32 and the current date 72 into respective embeddings and processing those embeddings at the date classifier ML model 50, the one or more processing devices 12 are configured to compute the output date “2024-01-26.” This computation relies on the current date 72 to provide a reference point for the relative temporal substring “the day after tomorrow.”

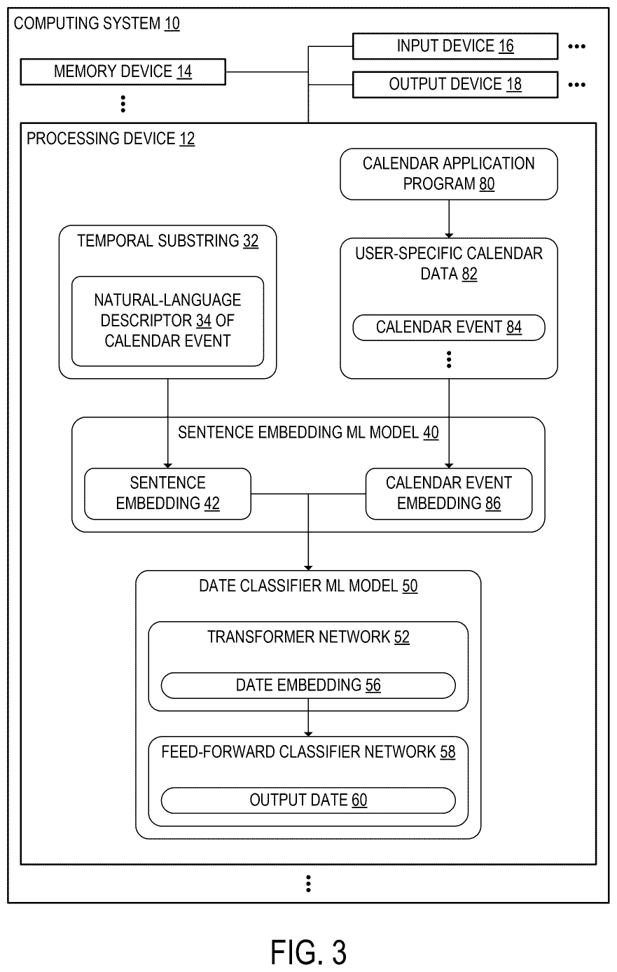

FIG. 3 schematically shows the computing system 10 in an example in which the one or more processing devices 12 are further configured to receive user-specific calendar data 82 at the sentence embedding ML model 40. The user-specific calendar data 82 may be received from a calendar application program 80 and may include one or more calendar events 84. In addition, in the example of FIG. 3, the temporal substring 32 includes a natural-language descriptor 34 of a calendar event 84 included in the user-specific calendar data 82 among the one or more calendar events 84.

Based at least in part on the user-specific calendar data 82, the one or more processing devices 12 are further configured to compute a calendar event embedding 86 at the sentence embedding ML model 40. At the date classifier ML model 50, the one or more processing devices 12 are further configured to compute the output date 60 based at least in part on the calendar event embedding 86. The one or more processing devices 12 are accordingly configured to incorporate the user-specific calendar data 82 into the determination of the output date 60. For example, when the one or more processing devices 12 receive the temporal substring “during my most recent vacation,” the one or more processing devices 12 may be configured to refer to the user-specific calendar data 82 to determine a date range at which a vacation calendar event occurred.

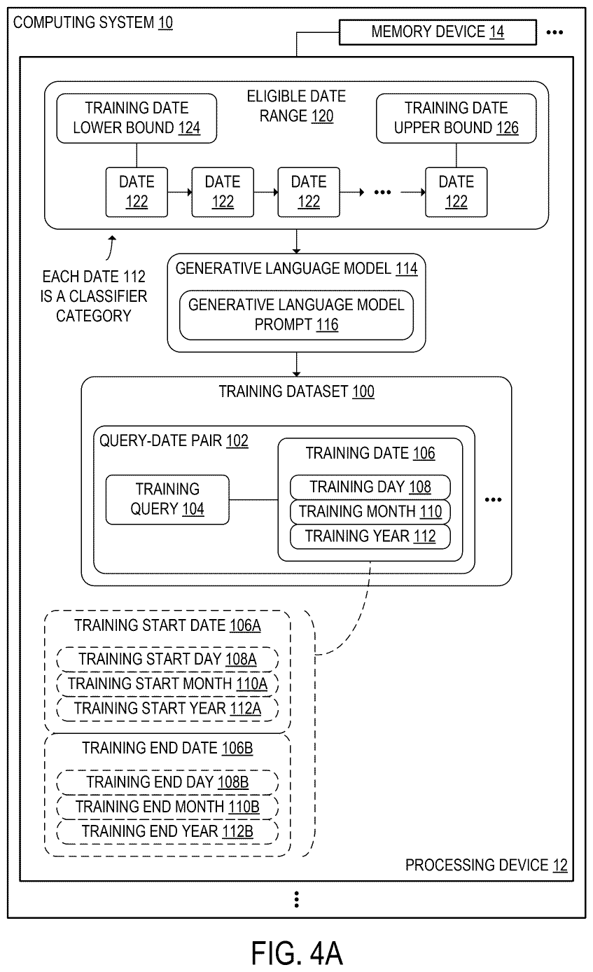

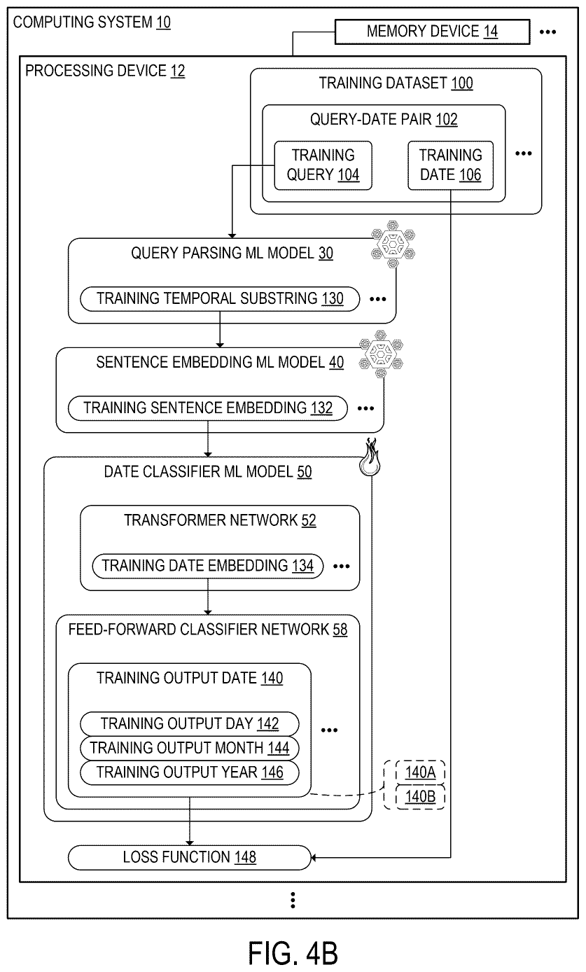

FIGS. 4A-4B schematically show the computing system 10 when the one or more processing devices 12 are configured to train the date classifier ML model 50. This training may be performed prior to receiving the input query 20 from the user at inferencing time. In some examples, the date classifier ML model 50 is trained at a first computing device included in the computing system 10 and is subsequently loaded into the memory of a separate computing device at which inferencing is performed.

FIG. 4A schematically shows the computing system 10 when the one or more processing devices 12 are configured to compute a training dataset 100 of the date classifier ML model 50. The one or more processing devices 12 are configured to train the date classifier ML model 50 using a training dataset 100 that includes a plurality of query-date pairs 102. Each of the query-date pairs 102 includes a training query 104 and a corresponding training date 106. The training query 104 is a text string, whereas the training date 106 includes a training day 108, a training month 110, and a training year 112. In some examples, the query-date pairs 102 each specify a date range rather than only including a single training date. In such examples, each query-date pair 102 may include a training start date 106A and a training end date 106B. The training start date 106A may include a training start day 108A, a training start month 110A, and a training start year 112A, and the training end date 106B may include a training end day 108B, a training end month 110B, and a training end year 112B.

In the example of FIG. 4A, the training dataset 100 includes, as the training dates 106, each date 122 included in an eligible date range 120 between a training date lower bound 124 and a training date upper bound 126. Each date 122 is a classifier category of the date classifier ML model 50. Thus, at the date classifier ML model 50, the one or more processing devices 12 are configured to select the output date 60 computed at inferencing time from among the dates 122 included in the eligible date range 120.

In some examples, as shown in FIG. 4A, at least a portion of the training dataset 100 is synthetic training data generated at a generative language model 114. In this example, the one or more processing devices 12 are configured to insert the dates 122 included in the eligible date range 120 into respective copies of a generative language model prompt 116 of the generative language model 114. The one or more processing devices 12 are further configured to perform respective inferencing passes at the generative language model 114 starting from those copies of the generative language model prompt 116 to compute corresponding query-date pairs 102.

FIG. 4B schematically shows the computing system 10 when the one or more processing devices 12 are configured to process the training dataset 100 to train the date classifier ML model 50. The query parsing ML model 30 and the sentence embedding ML model 40 are pretrained models, and respective weights of the query parsing ML model 30 and the sentence embedding ML model 40 are frozen during training of the date classifier ML model 50.

For each of the query-date pairs 102, the one or more processing devices 12 are configured to input the training query 104 into the query parsing ML model 30 to compute a training temporal substring 130. In some examples, rather than processing training queries 104 at the query parsing ML model 30 to compute training temporal substrings 130, the training temporal substrings 130 may be directly paired with the training dates 106 in the query-date pairs 102. In some examples, the generative language model 114 may be prompted to generate the training temporal substrings 130 directly, bypassing the query parsing ML model 30.

For each of the query-date pairs 102, the one or more processing devices 12 are further configured to input the training temporal substring 130 into the sentence embedding ML model 40. At the sentence embedding ML model 40, the one or more processing devices 12 are further configured to compute a training sentence embedding 132 based at least in part on the training temporal substring 130.

The one or more processing devices 12 are further configured to input the training sentence embedding 132 into the date classifier ML model 50. At the transformer network 52, the one or more processing devices 12 are configured to compute a training date embedding 134 based at least in part on the training sentence embedding 132. At the feed-forward classifier network 58, the one or more processing devices 12 are further configured to compute a training output date 140 based at least in part on the training date embedding 134. The training output date 140 includes a training output day 142, a training output month 144, and a training output year 146. In examples in which the training dataset 100 includes a plurality of training start dates 106A and training end dates 106B, the one or more processing devices 12 may be configured to compute a respective training output start date 140A and training output end date 140B for each query-date pair 102.

The one or more processing devices 12 are further configured to compute a value of a loss function 148 based at least in part on the training output date 140 computed at the date classifier ML model 50 and the training date 106 included in the query-date pair 102. The training date 106 is accordingly used as a ground-truth date. The loss function 148 may, for example, be a mean squared error, mean absolute error, or cross-entropy loss function.

The one or more processing devices 12 are further configured to perform gradient descent on the parameters of the date classifier ML model 50 with respect to the loss function 148 to thereby train the date classifier ML model 50. Respective parameters of both the transformer network 52 and the feed-forward classifier network 58 are trainable in the example of FIG. 4B. Thus, the one or more processing devices 12 are configured to train the date classifier ML model 50 to perform date classification on sentence embeddings 42 computed from input queries 20.

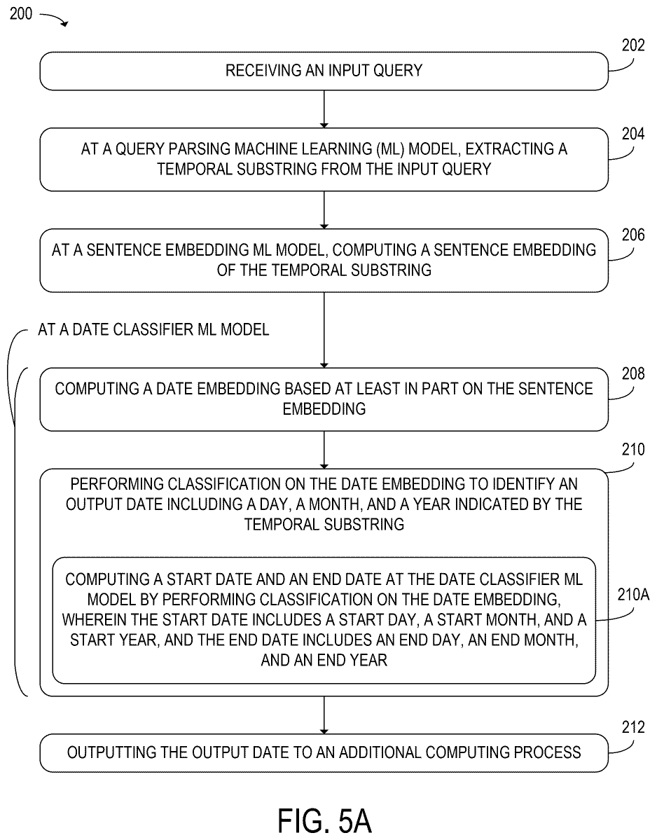

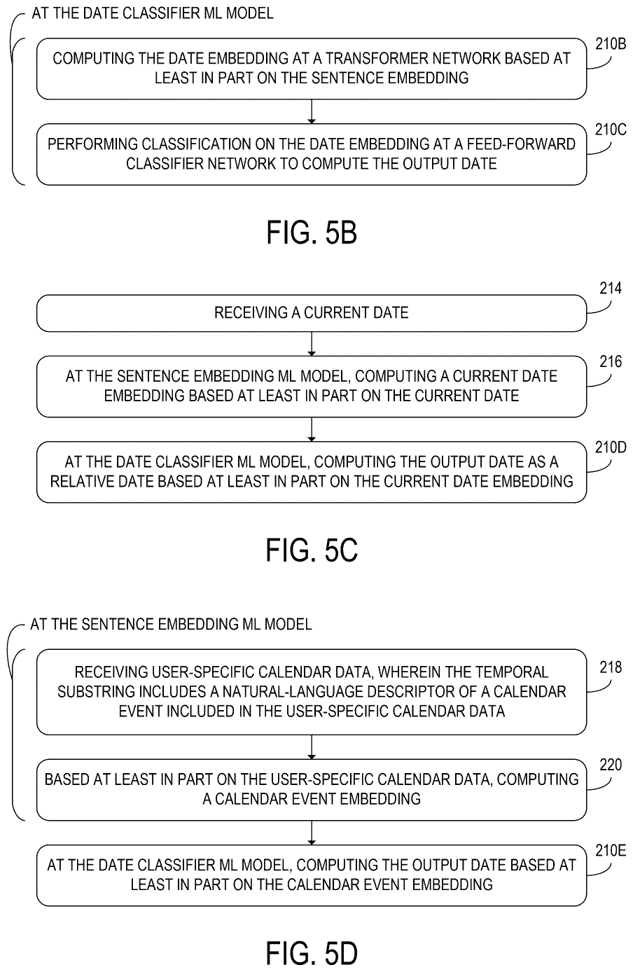

FIG. 5A shows a flowchart of a method 200 for use with a computing system to perform semantic date classification on text input. At step 202, the method 200 includes receiving an input query. The input query is a text input and may be a user input received over a user interface. In some examples, the input query may be preprocessed to convert the input query into a sequence of input tokens.

At step 204, the method 200 further includes extracting a temporal substring from the input query at a query parsing ML model. The temporal substring is a portion of the input query (e.g., a sequence of input tokens) that the query parsing ML model identifies as having time-related semantic content.

At step 206, the method 200 further includes computing a sentence embedding of the temporal substring at a sentence embedding ML model. Accordingly, semantic information is extracted from the temporal substring by mapping the temporal substring into the embedding space of the sentence embedding ML model.

Steps 208 and 210 of the method 200 are computed at a date classifier ML model. At step 208, the method 200 further includes computing a date embedding based at least in part on the sentence embedding. Thus, at step 208, the sentence embedding is mapped into another embedding space in which different dates are more easily distinguishable.

At step 210, the method 200 further includes performing classification on the date embedding to identify an output date including a day, a month, and a year indicated by the temporal substring. In some examples, a regression model is used instead of the date classifier ML model to compute the output date. Additionally or alternatively, in some examples, the date classifier ML model may further compute an output time within the output date.

In some examples, step 210 includes, at step 210A, computing a start date and an end date at the date classifier ML model by performing classification on the date embedding. In such examples, the start date includes a start day, a start month, and a start year, and the end date includes an end day, an end month, and an end year. The start date and the end date may be equal in such examples when the temporal substring semantically indicates a single date.

At step 212, the method 200 further includes outputting the output date to an additional computing process. In some examples, the additional computing process is a user interface, such as a GUI or an audio interface. In other examples, the output date is output to some other computing process such as a search process or a calendar application program.

FIGS. 5B-5E show additional steps of the method 200 that may be performed in some examples. FIG. 5B shows additional steps that may be performed at the date classifier ML model. At step 210B, step 210 includes computing the date embedding at a transformer network based at least in part on the sentence embedding. At step 210C, step 210 further includes performing classification on the date embedding at a feed-forward classifier network to compute the output date.

FIG. 5C shows additional steps of the method 200 that may be performed in examples in which the output date is computed as a relative date. At step 214, the method 200 further includes receiving a current date. The current date is the date of the day on which the input query is processed.

At step 216, the method 200 further includes, at the sentence embedding ML model, computing a current date embedding based at least in part on the current date. At step 210D, the method 200 further includes, at the date classifier ML model, computing the output date as a relative date based at least in part on the current date embedding. Accordingly, the date classifier ML model extracts the output date from a temporal substring that compares the output date to the current date.

FIG. 5D shows additional steps of the method 200 that may be performed in examples in which user-specific calendar data is further utilized when computing the output date. Steps 218 and 220, as shown in FIG. 5D, are performed at the sentence embedding ML model. At step 218, the method 200 further includes receiving user-specific calendar data. The temporal substring computed at step 204 in the example of FIG. 5D includes a natural-language descriptor of a calendar event included in the user-specific calendar data.

At step 220, the method 200 further includes computing a calendar event embedding based at least in part on the user-specific calendar data. Thus, the sentence embedding ML model processes the user-specific calendar data to extract semantic information. At step 210E, step 210 further includes, at the date classifier ML model, computing the output date based at least in part on the calendar event embedding. The calendar event embedding is therefore used as an additional source of semantic content utilized at the date classifier ML model to extract the output date.

FIG. 5E shows steps of the method 200 that may be performed to train the date classifier ML model. At step 222, the method 200 further includes training the date classifier ML model using a training dataset that includes a plurality of query-date pairs. Each of the query-date pairs includes a training query and a corresponding training date. As the training dates, the training dataset includes each date included in an eligible date range between a training date lower bound and a training date upper bound. In some examples, rather than including only one date in each query-date pair, each of the query-date pairs includes a training date range paired with the training query. The training date range includes a training start date and a training end date. In some examples, at step 222A, step 222 includes keeping respective weights of the query parsing ML model and the sentence embedding ML model frozen during training of the date classifier ML model.

At inferencing time, step 210 may further include, at step 210F, selecting the output date from among the dates included in the eligible date range. Thus, the eligible date range defines the classifier categories of the date classifier ML model, with one category for each of the dates.

Using the systems and methods discussed above, date extraction may be performed on semantic input queries that can have a wide variety of formats. For example, dates may be extracted from a prompt that specifies a relative date or that refers to a holiday, a season, a day-of-the-week, or a day-of-the-month. In addition, this date extraction may be robust to typographical errors and omitted information in the input query. In contrast, conventional heuristic-based date extraction techniques are less consistent across different semantic inputs and are unable to perform accurate date extraction from some types of natural-language inputs. The systems and methods discussed above may therefore allow machine-learning-based assistant systems to perform a wider range of tasks that utilize time-related natural language inputs.

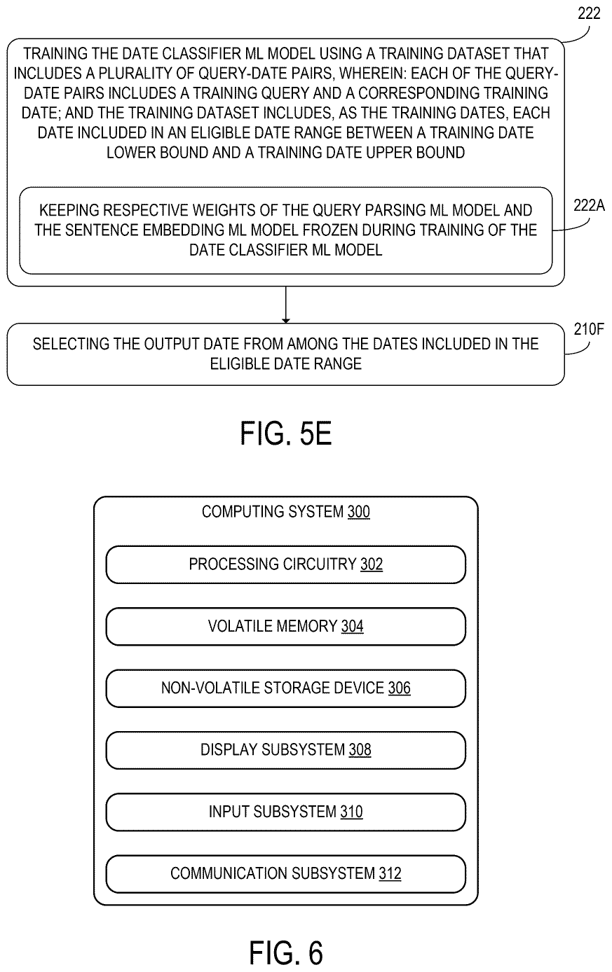

FIG. 6 schematically shows a non-limiting embodiment of a computing system 300 that can enact one or more of the methods and processes described above. Computing system 300 is shown in simplified form. Computing system 300 may embody the computing system 10 described above with reference to FIG. 1. Components of computing system 300 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 300 includes a logic processor 302 volatile memory 304, and a non-volatile storage device 306. Computing system 300 may optionally include a display subsystem 308, input subsystem 310, communication subsystem 312, and/or other components.

Logic processor 302 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the logic processor 302 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 306 includes one or more physical devices configured to hold instructions executable by the logic processors to implement the methods and processes described herein. When such methods and processes are implemented, the state of non-volatile storage device 306 may be transformed—e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by logic processor 302 to temporarily store information during processing of software instructions. It will be appreciated that volatile memory 304 typically does not continue to store instructions when power is cut to the volatile memory 304.

Aspects of logic processor 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via logic processor 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “cprogram,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device, and thus transform the state of the non-volatile storage device, the state of display subsystem 308 may likewise be transformed to visually represent changes in the underlying data. Display subsystem 308 may include one or more display devices utilizing virtually any type of technology. Such display devices may be combined with logic processor 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 300 to send and/or receive messages to and/or from other devices via a network such as the Internet.

The following paragraphs discuss several aspects of the present disclosure. According to one aspect of the present disclosure, a computing system is provided, including one or more processing devices configured to receive an input query. At a query parsing machine learning (ML) model, the one or more processing devices are further configured to extract a temporal substring from the input query. At a sentence embedding ML model, the one or more processing devices are further configured to compute a sentence embedding of the temporal substring. At a date classifier ML model, the one or more processing devices are further configured to compute a date embedding based at least in part on the sentence embedding and perform classification on the date embedding to identify an output date including a day, a month, and a year indicated by the temporal substring. The one or more processing devices are further configured to output the output date to an additional computing process. The above features may have the technical effect of identifying a semantically defined date in the input query, which may specify that date in a wide variety of different formats.

According to this aspect, the one or more processing devices may be configured to compute a start date and an end date at the date classifier ML model by performing classification on the date embedding. The start date may include a start day, a start month, and a start year. The end date may include an end day, an end month, and an end year. The above features may have the technical effect of identifying a range of dates specified in the input query.

According to this aspect, the one or more processing devices may be configured to receive a current date. At the sentence embedding ML model, the one or more processing devices may be further configured to compute a current date embedding based at least in part on the current date. At the date classifier ML model, the one or more processing devices may be further configured to compute the output date as a relative date based at least in part on the current date embedding. The above features may have the technical effect of identifying a date specified in the input query with reference to the current date.

According to this aspect, the temporal substring may be a natural-language descriptor of the output date. The above feature may have the technical effect of identifying a date indicated by a natural language input.

According to this aspect, the temporal substring may include a natural-language indication of a holiday, a season, a day-of-the-week, or a day-of-the-month. The above feature may have the technical effect of identifying a date specified as a natural language input in an at least partially non-numerical format.

According to this aspect, the one or more processing devices may be further configured to receive user-specific calendar data at the sentence embedding ML model. The temporal substring may include a natural-language descriptor of a calendar event included in the user-specific calendar data. At the sentence embedding ML model, based at least in part on the user-specific calendar data, the one or more processing devices may be further configured to compute a calendar event embedding. At the date classifier ML model, the one or more processing devices may be further configured to compute the output date based at least in part on the calendar event embedding. The above features may have the technical effect of identifying a date specified in the input query with reference to an event in the user's calendar.

According to this aspect, the date classifier ML model may include a transformer network configured to compute the date embedding based at least in part on the sentence embedding. The date classifier ML model may further include a feed-forward classifier network configured to perform classification on the date embedding to compute the output date. The above features may have the technical effect of converting the sentence embedding into a date embedding that is more easily classified at the feed-forward classifier network.

According to this aspect, the one or more processing devices may be further configured to train the date classifier ML model using a training dataset that includes a plurality of query-date pairs. Each of the query-date pairs may include a training query and a corresponding training date. The training dataset may include, as the training dates, each date included in an eligible date range between a training date lower bound and a training date upper bound. The above features may have the technical effect of training the date classifier ML model with each date in the eligible date range as a classifier category.

According to this aspect, at the date classifier ML model, the one or more processing devices may be configured to select the output date from among the dates included in the eligible date range. The above features may have the technical effect of classifying the input queries among each of the dates included in the eligible date range.

According to this aspect, respective weights of the query parsing ML model and the sentence embedding ML model may be frozen during training of the date classifier ML model. The above features may have the technical effect of retaining the pretrained capabilities of the query parsing ML model and the sentence embedding ML model during the training of the date classifier ML model.

According to another aspect of the present disclosure, a method for use with a computing system is provided. The method includes, at a query parsing machine learning (ML) model, extracting a temporal substring from the input query. At a sentence embedding ML model, the method further includes computing a sentence embedding of the temporal substring. At a date classifier ML model, the method further includes computing a date embedding based at least in part on the sentence embedding. At the date classifier ML model, the method further includes performing classification on the date embedding to identify an output date including a day, a month, and a year indicated by the temporal substring. The method further includes outputting the output date to an additional computing process. The above features may have the technical effect of identifying a semantically defined date in the input query, which may specify that date in a wide variety of different formats.

According to this aspect, the method may further include computing a start date and an end date at the date classifier ML model by performing classification on the date embedding. The start date may include a start day, a start month, and a start year. The end date may include an end day, an end month, and an end year. The above features may have the technical effect of identifying a range of dates specified in the input query.

According to this aspect, the method may further include receiving a current date. At the sentence embedding ML model, the method may further include computing a current date embedding based at least in part on the current date. At the date classifier ML model, the method may further include computing the output date as a relative date based at least in part on the current date embedding. The above features may have the technical effect of identifying a date specified in the input query with reference to the current date.

According to this aspect, the temporal substring may be a natural-language descriptor of the output date. The above feature may have the technical effect of identifying a date indicated by a natural language input.

According to this aspect, the temporal substring may include a natural-language indication of a holiday, a season, a day-of-the-week, or a day-of-the-month. The above feature may have the technical effect of identifying a date specified as a natural language input in an at least partially non-numerical format.

According to this aspect, the method may further include receiving user-specific calendar data at the sentence embedding ML model. The temporal substring may include a natural-language descriptor of a calendar event included in the user-specific calendar data. Based at least in part on the user-specific calendar data, the method may further include computing a calendar event embedding. At the date classifier ML model, the method may further include computing the output date based at least in part on the calendar event embedding. The above features may have the technical effect of identifying a date specified in the input query with reference to an event in the user's calendar.

According to this aspect, at the date classifier ML model, the method may further include computing the date embedding at a transformer network based at least in part on the sentence embedding. At the date classifier ML model, the method may further include performing classification on the date embedding at a feed-forward classifier network to compute the output date. The above features may have the technical effect of converting the sentence embedding into a date embedding that is more easily classified at the feed-forward classifier network.

According to this aspect, the method may further include training the date classifier ML model using a training dataset that includes a plurality of query-date pairs. Each of the query-date pairs includes a training query and a corresponding training date. The training dataset may include, as the training dates, each date included in an eligible date range between a training date lower bound and a training date upper bound. The above features may have the technical effect of training the date classifier ML model with each date in the eligible date range as a classifier category.

According to this aspect, the output date may be selected from among the dates included in the eligible date range. The above features may have the technical effect of classifying the input queries among each of the dates included in the eligible date range.

According to another aspect of the present disclosure, a computing system is provided, including one or more processing devices configured to receive a training dataset that includes a plurality of query-date pairs. Each of the query-date pairs includes a training query and a corresponding training date. The training dataset includes, as the training dates, each date included in an eligible date range between a training date lower bound and a training date upper bound. The one or more processing devices are further configured to train a date classifier ML model on the training dataset. The one or more processing devices are further configured to receive an input query. At a query parsing machine learning (ML) model, the one or more processing devices are further configured to extract a temporal substring from the input query. At a sentence embedding ML model, the one or more processing devices are further configured to compute a sentence embedding of the temporal substring. At a date classifier ML model, the one or more processing devices are further configured to compute a date embedding based at least in part on the sentence embedding. At the date classifier ML model, the one or more processing devices are further configured to perform classification on the date embedding to identify an output date including a day, a month, and a year indicated by the temporal substring. The date classifier model includes a transformer network configured to compute the date embedding and a feed-forward classifier network configured to perform classification on the date embedding. The one or more processing devices are further configured to output the output date to an additional computing process. The above features may have the technical effect of identifying a semantically defined date in the input query, which may specify that date in a wide variety of different formats.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
one or more processing devices configured to:
receive an input query;
at a query parsing machine learning (ML) model, extract a temporal substring from the input query;
at a sentence embedding ML model, compute a sentence embedding of the temporal substring;
at a date classifier ML model:
compute a date embedding based at least in part on the sentence embedding, wherein computing the date embedding includes upscaling an embedding space region of the sentence embedding ML model that encodes date-related semantic information; and
perform classification on the date embedding to identify an output date including a day, a month, and a year indicated by the temporal substring; and
output the output date to an additional computing process.

2. The computing system of claim 1, wherein:
the one or more processing devices are configured to compute a start date and an end date at the date classifier ML model by performing classification on the date embedding;
the start date includes a start day, a start month, and a start year; and
the end date includes an end day, an end month, and an end year.

3. The computing system of claim 1, wherein the one or more processing devices are further configured to:
receive a current date;
at the sentence embedding ML model, compute a current date embedding based at least in part on the current date; and
at the date classifier ML model, compute the output date as a relative date based at least in part on the current date embedding.

4. The computing system of claim 1, wherein the temporal substring is a natural-language descriptor of the output date.

5. The computing system of claim 4, wherein the temporal substring includes a natural-language indication of a holiday, a season, a day-of-the-week, or a day-of-the-month.

6. The computing system of claim 4, wherein the one or more processing devices are further configured to:
at the sentence embedding ML model:
receive user-specific calendar data, wherein the temporal substring includes a natural-language descriptor of a calendar event included in the user-specific calendar data; and
based at least in part on the user-specific calendar data, compute a calendar event embedding; and
at the date classifier ML model, compute the output date based at least in part on the calendar event embedding.

7. The computing system of claim 1, wherein the date classifier ML model includes:
a transformer network configured to compute the date embedding based at least in part on the sentence embedding; and
a feed-forward classifier network configured to perform classification on the date embedding to compute the output date.

8. The computing system of claim 1, wherein:
the one or more processing devices are further configured to train the date classifier ML model using a training dataset that includes a plurality of query-date pairs;
each of the query-date pairs includes a training query and a corresponding training date; and
the training dataset includes, as the training dates, each date included in an eligible date range between a training date lower bound and a training date upper bound.

9. The computing system of claim 8, wherein, at the date classifier ML model, the one or more processing devices are configured to select the output date from among the dates included in the eligible date range.

10. The computing system of claim 8, wherein respective weights of the query parsing ML model and the sentence embedding ML model are frozen during training of the date classifier ML model.

11. A method for use with a computing system, the method comprising:
receiving an input query;
at a query parsing machine learning (ML) model, extracting a temporal substring from the input query;
at a sentence embedding ML model, computing a sentence embedding of the temporal substring;
at a date classifier ML model:
computing a date embedding based at least in part on the sentence embedding, wherein computing the date embedding includes upscaling an embedding space region of the sentence embedding ML model that encodes date-related semantic information; and
performing classification on the date embedding to identify an output date including a day, a month, and a year indicated by the temporal substring; and
outputting the output date to an additional computing process.

12. The method of claim 11, further comprising computing a start date and an end date at the date classifier ML model by performing classification on the date embedding, wherein:
the start date includes a start day, a start month, and a start year; and
the end date includes an end day, an end month, and an end year.

13. The method of claim 11, further comprising:
receiving a current date;
at the sentence embedding ML model, computing a current date embedding based at least in part on the current date; and
at the date classifier ML model, computing the output date as a relative date based at least in part on the current date embedding.

14. The method of claim 11, wherein the temporal substring is a natural-language descriptor of the output date.

15. The method of claim 14, wherein the temporal substring includes a natural-language indication of a holiday, a season, a day-of-the-week, or a day-of-the-month.

16. The method of claim 14, further comprising:
at the sentence embedding ML model:
receiving user-specific calendar data, wherein the temporal substring includes a natural-language descriptor of a calendar event included in the user-specific calendar data; and
based at least in part on the user-specific calendar data, computing a calendar event embedding; and
at the date classifier ML model, computing the output date based at least in part on the calendar event embedding.

17. The method of claim 11, further comprising, at the date classifier ML model:
computing the date embedding at a transformer network based at least in part on the sentence embedding; and
performing classification on the date embedding at a feed-forward classifier network to compute the output date.

18. The method of claim 11, further comprising training the date classifier ML model using a training dataset that includes a plurality of query-date pairs, wherein:
each of the query-date pairs includes a training query and a corresponding training date; and
the training dataset includes, as the training dates, each date included in an eligible date range between a training date lower bound and a training date upper bound.

19. The method of claim 18, wherein the output date is selected from among the dates included in the eligible date range.

20. A computing system comprising:
one or more processing devices configured to:
receive a training dataset that includes a plurality of query-date pairs, wherein:
each of the query-date pairs includes a training query and a corresponding training date; and
the training dataset includes, as the training dates, each date included in an eligible date range between a training date lower bound and a training date upper bound;
train a date classifier ML model on the training dataset;
receive an input query;
at a query parsing machine learning (ML) model, extract a temporal substring from the input query;
at a sentence embedding ML model, compute a sentence embedding of the temporal substring;
at the date classifier ML model:
compute a date embedding based at least in part on the sentence embedding, wherein computing the date embedding includes upscaling an embedding space region of the sentence embedding ML model that encodes date-related semantic information; and
perform classification on the date embedding to identify an output date including a day, a month, and a year indicated by the temporal substring, wherein the date classifier model includes:
a transformer network configured to compute the date embedding; and
a feed-forward classifier network configured to perform classification on the date embedding; and
output the output date to an additional computing process.
